(19) United States
(12) Patent Application Publication
(10) Pub. No.: US 2022/0365240 A1
(43) Pub. Date: Nov. 17, 2022

(54) Determination Of Material State Behind Casing Using Multi-Receiver Ultrasonic Data And Machine Learning

(71) Applicant: Halliburton Energy Services, Inc., Houston, TX (US)

(72) Inventors: Andrew Lyle Imrie, Aberdeen (GB); Amit Padhi, Houston, TX (US); Qingtao Sun, Spring, TX (US); Sonali Pattnaik, Houston, TX (US)

(73) Assignee: Halliburton Energy Services, Inc., Houston, TX (US)

(21) Appl. No.: 17/693,053

(22) Filed: Mar. 11, 2022

Related U.S. Application Data
(60) Provisional application No. 63/187,734, filed on May 12, 2021.

(51) Int. Cl. G01V 1/50; G01V 1/28; G06N 20/00

(52) U.S. Cl. CPC G01V 1/50; G01V 1/282; G06N 20/00; G01V 2210/614

(57) ABSTRACT

A method for identifying a material behind a pipe string. The method may comprise disposing an acoustic logging tool into a wellbore, insonifying a pipe string within the wellbore with the acoustic logging tool, recording sonic or ultrasonic data. The method may further comprise inputting the sonic or ultrasonic data into trained a machine learning model and identifying the material behind the pipe string using the trained machine learning model.

### BACKGROUND

For oil and gas exploration and production, a network of wells, installations and other conduits may be established by connecting sections of metal pipe together. For example, a well installation may be completed, in part, by lowering multiple sections of metal pipe (i.e., a casing string) into a wellbore, and cementing the casing string in place. In some well installations, multiple casing strings are employed (e.g., a concentric multi-string arrangement) to allow for different operations related to well completion, production, or enhanced oil recovery (EOR) options.

During a well installations' life, logging operations may be performed to determine material behind a pipe string. These operations may be performed by a variety of logging tools that may utilize acoustic methods or electromagnetic methods to identify material behind a pipe string. However, the tools utilized often only utilize one form of measurement. Additionally, the accuracy with predicting the material behind casing is often low as human determination of recorded data may be faulty.

### BRIEF DESCRIPTION OF THE DRAWINGS

These drawings illustrate certain aspects of some examples of the present disclosure and should not be used to limit or define the disclosure.

FIG. 1 illustrates a system including an acoustic logging tool.

FIG. 2 illustrates an example of a transmitter and a receiver.

FIG. 3 illustrates another example of the transmitter and the receiver configuration.

FIG. 4 illustrates a machine learning loop.

FIG. 5 illustrates the architecture of an information handling system.

FIG. 6 illustrates the chipset of an information handling system.

FIG. 7 illustrates at least one information handling system in a network.

FIG. 8 illustrates a schematic configuration of a neural network;

FIG. 9A illustrates a graph of waveforms captured by multiple receivers in a pitch-catch arrangements.

FIG. 9B illustrates a graph computed attribute variation with receiver and annulus material.

FIGS. 9C and 9D are graphs utilizing synthetic data to predict material behind pipe casing.

FIGS. 10A and 10B illustrate workflows for identifying material behind pipe string.

FIGS. 11A-11C illustrate one or more processed images.

FIGS. 12A-12D illustrate narrow channel classification of images.

FIGS. 13A-13D illustrate wide channel classification of images.

FIG. 14 illustrates a workflow for machine learning operations.

FIG. 15 illustrates a pattern matching method.

FIG. 16 illustrates dividing an image into multiple images for pattern matching.

FIGS. 17A and 17B illustrate the identification of matching images to each other during pattern matching.

### DETAILED DESCRIPTION

This disclosure may generally relate to methods for identifying materials behind a pipe string with an acoustic logging tool. Acoustic sensing may provide continuous in situ measurements of parameters related to determining the material behind a pipe string. As a result, acoustic sensing may be used in cased borehole monitoring applications. As disclosed herein, acoustic logging tools may be used to emit an acoustic signal which may be reflected and/or refracted off different interfaces inside a wellbore.

The methods and systems described below may utilize a machine learning model, such as random forest, neural network, or other machine learning models, to train with data comprising of input features from material outside casing labeling (solid, liquid, gas). The trained model receives newly acquired data containing new input feature values and predicts material outside a pipe string. New input feature values comprising of sonic or ultrasonic pulse-echo data based calculated impedance, sonic or ultrasonic casing flexural mode wavelet attributes from three or more receivers, casing thickness, mud inside casing properties (like impedance and attenuation) and eccentricity information (like casing-transducer offset and angle of incidence) and are obtained from acquired data, to be discussed later.

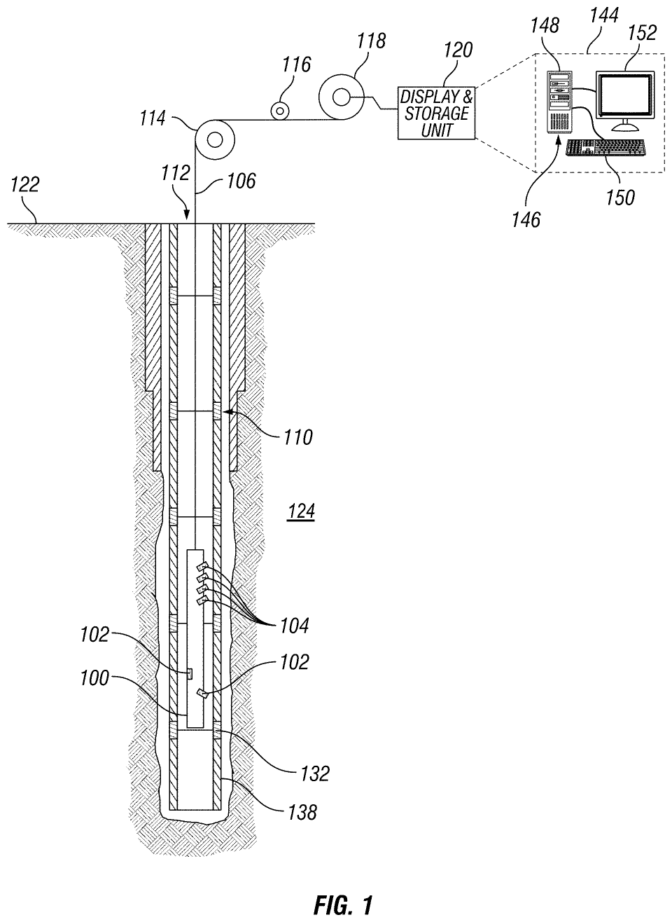

FIG. 1 illustrates an operating environment for an acoustic logging tool 100 as disclosed herein. Acoustic logging tool 100 may comprise a transmitter 102 and/or at least one receiver 104. In examples, there may be any number of transmitters 102 and/or at least one receiver 104, which may be disponed on acoustic logging tool 100. Acoustic logging tool 100 may be operatively coupled to a conveyance 106 (e.g., wireline, slickline, coiled tubing, pipe, downhole tractor, and/or the like) which may provide mechanical suspension, as well as electrical connectivity, for acoustic logging tool 100. Conveyance 106 and acoustic logging tool 100 may extend within casing string 108 to a desired depth within the wellbore 110. Wellbore 110 may extend vertically or horizontally into formation 124. Conveyance 106, which may comprise one or more electrical conductors, may exit wellhead 112, may pass around pulley 114, may engage odometer 116, and may be reeled onto winch 118, which may be employed to raise and lower the tool assembly in the wellbore 110. Signals recorded by acoustic logging tool 100 may be stored on memory and then processed by display and storage unit 120 after recovery of acoustic logging tool 100 from wellbore 110. Alternatively, signals recorded by acoustic logging tool 100 may be conducted to display and storage unit 120 by way of conveyance 106. Display and storage unit 120 may process the signals, and the information contained therein may be displayed for an operator to observe and stored for future processing and reference. Alternatively, signals may be processed downhole prior to receipt by display and storage unit 120 or both downhole and at surface 122, for example, by display and storage unit 120. Display and storage unit 120 may also contain an apparatus for supplying control signals and power to acoustic logging tool 100. Typical casing string 108 may extend from wellhead 112 at or above ground level to a selected depth within a wellbore 110. Casing string 108 may comprise a plurality of joints 130 or segments of casing string 108, each joint 130 being connected to the adjacent segments by a collar 132. There may be any number of layers in casing string 108. For example, a first casing 134 and a second casing 136. It should be noted that there may be any number of casing layers.

FIG. 1 also illustrates a typical pipe string 138, which may be positioned inside of wellbore 110. Pipe string 138 may be production tubing, tubing string, casing string, or another pipe disposed within wellbore 110. Pipe string 138 may comprise concentric pipes. It should be noted that concentric pipes may be connected by collars 132. Acoustic logging tool 100 may be dimensioned so that it may be lowered into the wellbore 110 through pipe string 138, thus avoiding the difficulty and expense associated with pulling pipe string 138 out of wellbore 110.

In logging systems, such as, for example, logging systems utilizing the acoustic logging tool 100, a digital telemetry system may be employed, wherein an electrical circuit may be used to both supply power to acoustic logging tool 100 and to transfer data between display and storage unit 120 and acoustic logging tool 100. A DC voltage may be provided to acoustic logging tool 100 by a power supply located above ground level, and data may be coupled to the DC power conductor by a baseband current pulse system. Alternatively, acoustic logging tool 100 may be powered by batteries located within the downhole tool assembly, and/or the data provided by acoustic logging tool 100 may be stored within the downhole tool assembly, rather than transmitted to the surface during logging (corrosion detection).

Acoustic logging tool 100 may be used for excitation of transmitter 102. As illustrated, at least one receiver 104 may be positioned on the acoustic logging tool 100 at selected distances (e.g., axial spacing) away from transmitter 102. The axial spacing of at least one receiver 104 from transmitter 102 may vary, for example, from about 0 inches (0 cm) to about 40 inches (101.6 cm) or more. In some embodiments, at least one receiver 104 may be placed near the transmitter 102 (e.g., within at least 1 inch (2.5 cm)) while one or more additional receivers may be spaced from 1 foot (30.5 cm) to about 5 feet (152 cm) or more from the transmitter 102. It should be understood that the configuration of acoustic logging tool 100 shown on FIG. 1 is merely illustrative and other configurations of acoustic logging tool 100 may be used with the present techniques. In addition, acoustic logging tool 100 may comprise more than one transmitter 102 and at least one receiver 104. For example, an array of at least one receiver 104 may be used. Transmitters 102 may comprise any suitable acoustic source for generating acoustic waves downhole, including, but not limited to, monopole and multipole sources (e.g., dipole, cross-dipole, quadrupole, hexapole, or higher order multi-pole transmitters). Specific examples of suitable transmitters 102 may comprise, but are not limited to, piezoelectric elements, bender bars, transducers, or other transducers suitable for generating acoustic waves downhole. At least one receiver 104 may comprise any suitable acoustic receiver suitable for use downhole, including piezoelectric elements that may convert acoustic waves into an electric signal.

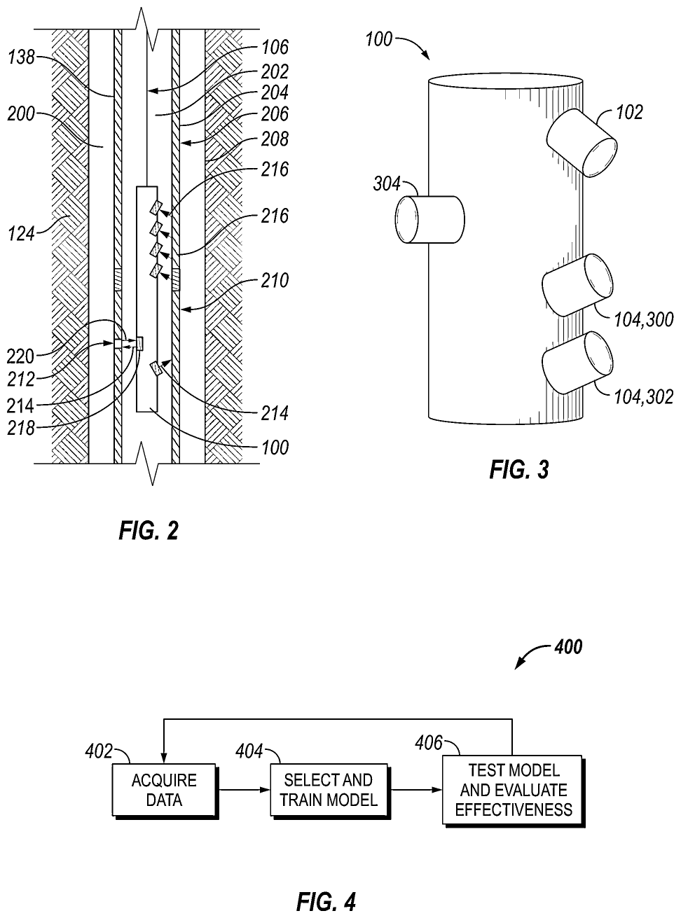

FIG. 2 illustrates acoustic logging tool 100 during logging operations. As illustrated, logging operations (for the methods and systems discussed below) may utilize sonic or ultrasonic pulse-echo and pitch catch flexural waves generated from one or more transmitters 102 and recorded by a plurality of at least one receiver 104 to predict a material state of material 200 behind pipe string 138. During operations, logging tool 100 is suspended in mud 202 by conveyance 106. As noted above, to form an acoustic log, sonic or ultrasonic pulse-echo and pitch catch flexural waves are generated and recorded. Both waves, which are produced by different systems and methods on acoustic logging tool 100, may be used to analyze material 200 behind pipe string 138. As illustrated, there may be at least three interfaces in which acoustic waves may reflect and/or refract. Those interfaces are a first interface 204, a second interface 206, and third interface 208. First interface 204 is defined as a location in which mud 202 contacts the inner surface of pipe string 138. At a first interface a large reflection may occur, however acoustic waves which refract through a first interface may approach a second interface 206. Second interface 206 is defined as a location in which the outer surface of pipe string 138 contacts with a material 200. The acoustic waves which refract through second interface may be implemented to evaluate material 200. Third interface 208 is defined as a location in which material 200 contacts formation 124. For pitch-catch methods 210, transmitters 102 and at least one receiver 104 may be tilted at or about 35 degrees with respect to a longitudinal axis of acoustic tool 100. This may allow for generation of sonic or ultrasonic waves 214 from transmitter 102 to travel along any of the above identified interfaces and be recorded by at least one receiver 104 as one or more flexural waves 216. Flexural waves 216 may be sonic or ultrasonic waves 214. In a pulse-echo method 212, sonic or ultrasonic waves 214 may be transmitted and received as a S1 mode wave 220 by transducer 218. In such method, sonic or ultrasonic waves 214 may be transmitted from transducer 218 about perpendicular to pipe casing 138. Sonic or ultrasonic waves 214 may reflect and/or refract off any of the above identified interfaces and is recorded as one or more S1 mode wave 220 by transducer 218. Recorded S1 mode wave 220 may be processed similarly to flexural waves 216. Processed S1 mode wave 220 and flexural waves 216 may be recorded as acoustic impedance in units of Rayls. The acoustic log may further be processed with machine learning models to process the recorded flexural waves 216 and S1 mode wave 220 to determine the material 200 behind pipe string 138.

FIG. 3 is a perspective view of acoustic logging tool 100. As illustrated, transmitters 102 and at least one receiver 104 are inverted, as compared to the embodiment in FIGS. 1 and 2. However, acoustic logging tool 100 and the methods described may still operate and function the same way as described above and below. As illustrated, acoustic logging tool 100 may comprise a transmitter 102 and at least one receiver 104, which may be arranged in a pitch and catch configuration. That is, transmitter 102 may be a pitch transducer, and at least one receiver 104 may be near and far catch transducers spaced at suitable near and far axial distances from transmitter 102, respectively. In such a configuration, transmitter 102 (i.e., may also be referred to as a source pitch transducer) emits sonic or ultrasonic waves while at least one receiver 104 (i.e., may also be referred to as catch transducers) receive the sonic or ultrasonic waves after reflection and/or refraction from the wellbore fluid, casing, cement and formation and record the received waves as time-domain waveforms. At least one receiver 104 may further be identified as near receiver 300 and far receiver 302. Near receiver 300 being at least one receiver 104 closest to transmitter 102 and far receiver 302 being at least one receiver 104 the furthest away from transmitter 102. Because the distance between near receiver 300 and far receiver 302 is known, differences between the reflected and/or refracted waveforms received at least one receiver 104 provide information about attenuation that may be correlated to material 200 (e.g., referring to FIG. 2) in the annular wellbore region, and they allow a circumferential depth of investigation around wellbore 110 (e.g., referring to FIG. 1).

The pitch-catch transducer pairing may have different frequency, spacing, and/or angular orientations based on environmental effects and/or tool design. For example, if transmitter 102 and at least one receiver 104 operate in the sonic range, spacing ranging from three to fifteen feet may be appropriate, with three and five foot spacing may also be suitable. If transmitter 102 and at least one receiver 104 operate in the sonic or ultrasonic range, the spacing may be less.

Acoustic logging tool 100 may comprise, in addition or as an alternative to at least one receiver 104, a pulsed echo sonic or ultrasonic transducer 304. Pulsed echo sonic or ultrasonic transducer 304 may, for instance, operate at a frequency from 80 kHz up to 800 kHz. The optimal transducer frequency is a function of the casing size, weight, mud environment and other conditions. Pulsed echo sonic or ultrasonic transducer 304 transmits waves, receives the same waves after they reflect off of the casing, annular space and formation, and records the waves as time-domain waveforms. As noted above, reflected/refracted S1 mode wave 220 (e.g., referring to FIG. 2) that are recorded may be further processed into an acoustic log, that may be further processed by machine learning models to determine material 200 (e.g., referring to FIG. 1) behind pipe string 138.

Referring back to FIG. 1, transmission of sonic or ultrasonic waves by the transmitter 102 and the recordation of signals by at least one receiver 104 may be controlled by display and storage unit 120, which may comprise an information handling system 144. As illustrated, the information handling system 144 may be a component of the display and storage unit 120. Alternatively, the information handling system 144 may be a component of acoustic logging tool 100. An information handling system 144 may comprise any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 144 may be a personal computer, a network storage device, or any other suitable device and may vary in size, shape, performance, functionality, and price. Information handling system 144 may comprise a processing unit 146 (e.g., microprocessor, central processing unit, etc.) that may process acoustic log data by executing software or instructions obtained from a local non-transitory computer readable media 148 (e.g., optical disks, magnetic disks). The non-transitory computer readable media 148 may store software or instructions of the methods described herein. Non-transitory computer readable media 148 may comprise any instrumentality or aggregation of instrumentalities that may retain data and/or instructions for a period of time. Non-transitory computer readable media 148 may comprise, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination thereof the foregoing. Information handling system 144 may also comprise input device(s) 150 (e.g., keyboard, mouse, touchpad, etc.) and output device(s) 152 (e.g., monitor, printer, etc.). The input device(s) 150 and output device(s) 152 provide a user interface that enables an operator to interact with acoustic logging tool 100 and/or software executed by processing unit 146, For example, information handling system 144 may enable an operator to select analysis options, view collected log data, view analysis results, and/or perform other tasks.

FIG. 4 illustrates a machine learning loop 400. Machine learning loop 400 may be performed or stored within information handling 144. Machine learning loop 400 incorporates a data acquisition phase 402, a select and train model phase 404, and a test model an evaluate effectiveness phase 406. In data acquisition phase 402 measurements may be recorded from acoustic logging tool 100 and processed by information handling system 144. The resulting data may be transferred into acquire data phase 402 by a bus or any standard data transferring techniques. The transferred data may be populated into a data structure through a population algorithm. The data structure may comprise but is not limited to vectors, matrices, or clusters. The means of populating the data structure with the population algorithm may incorporate randomly populating data structure with the resulting data or sequentially filling the data in the order it was processed by information handling system 144. Additionally, the population algorithm may work methodically through statistical or operative algorithms which analyze the data and maximizes the shape and data location for an effective data structure. Further, the population algorithm may populate the data structure with synthetic data or lab data as well as measurements from acoustic logging tool 100.

The data structure may be transferred to select and train model phase 404 through a bus or any standard data transferring techniques. In select and train model phase 404 a learning model is selected. The Learning model may be a supervised, unsupervised, semi-supervised, or reinforcement learning algorithm. Learning algorithms are diverse and may be changed to be better suited for different applications. Once a learning model is selected the data structure is divided into a training set and a test set by a predetermined amount. Each line of training data is used iteratively as an input and output to the learning model. After each line of training data is iterated through the learning model it may be considered a trained learning model. The test set and trained learning model may be transferred from select and train model phase 404 to test model and evaluate effectiveness phase 406 through bus or any standard data transferring techniques. Select model and evaluate effectiveness phase 406 iterates the test set through the trained learning model to produce a score for trained learning model.

Subsequently the trained learning model is evaluated. The score obtained is considered in addition to the cost to train learning model. The cost to the train learning model may comprise parameters such as training time and processing delegation. Additionally costs and benefits from acquire data phase may be considered as well. The effectiveness of the trained model is variant in different applications. Machine learning loop 400 may further comprise feedback. Feedback may comprise a wide array of alterations to build a more effective trained model. For example, alterations may change the population algorithm, the learning model to be employed, how much data structure is divided into training set and test, or cutting down the data structure.

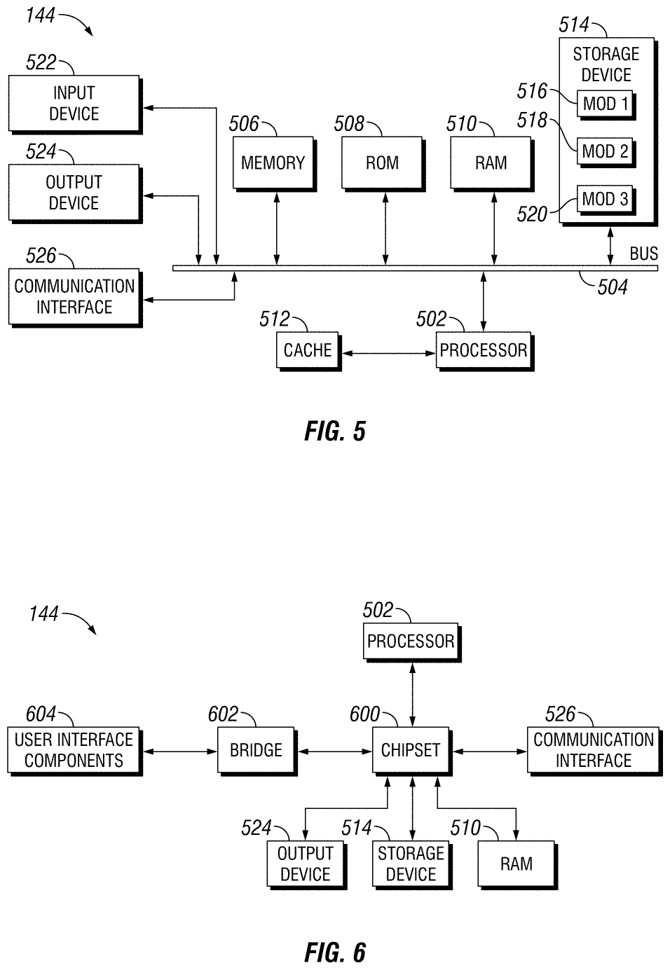

FIG. 5 illustrates an example information handling system 144 which may be employed to perform various steps, methods, and techniques disclosed herein. Persons of ordinary skill in the art will readily appreciate that other system examples are possible. As illustrated, information handling system 144 comprises a processing unit (CPU or processor) 502 and a system bus 504 that couples various system components including system memory 506 such as read only memory (ROM) 508 and random-access memory (RAM) 510 to processor 502. Processors disclosed herein may all be forms of this processor 502. Information handling system 144 may comprise a cache 512 of high-speed memory connected directly with, in close proximity to, or integrated as part of processor 502. Information handling system 144 copies data from memory 506 and/or storage device 514 to cache 512 for quick access by processor 502. In this way, cache 512 provides a performance boost that avoids processor 502 delays while waiting for data. These and other modules may control or be configured to control processor 502 to perform various operations or actions. Other system memory 506 may be available for use as well. Memory 506 may comprise multiple different types of memory with different performance characteristics. It may be appreciated that the disclosure may operate on information handling system 144 with more than one processor 502 or on a group or cluster of computing devices networked together to provide greater processing capability. Processor 502 may comprise any general-purpose processor and a hardware module or software module, such as first module 516, second module 518, and third module 520 stored in storage device 514, configured to control processor 502 as well as a special-purpose processor where software instructions are incorporated into processor 502. Processor 502 may be a self-contained computing system, containing multiple cores or processors, a bus, memory controller, cache, etc. A multi-core processor may be symmetric or asymmetric. Processor 502 may comprise multiple processors, such as a system having multiple, physically separate processors in different sockets, or a system having multiple processor cores on a single physical chip. Similarly, processor 502 may comprise multiple distributed processors located in multiple separate computing devices but working together such as via a communications network. Multiple processors or processor cores may share resources such as memory 506 or cache 512 or may operate using independent resources. Processor 502 may comprise one or more state machines, an application specific integrated circuit (ASIC), or a programmable gate array (PGA) including a field PGA (FPGA).

Each individual component discussed above may be coupled to system bus 504, which may connect each and every individual component to each other. System bus 504 may be any of several types of bus structures including a memory bus or memory controller, a peripheral bus, and a local bus using any of a variety of bus architectures. A basic input/output (BIOS) stored in ROM 508 or the like, may provide the basic routine that helps to transfer information between elements within information handling system 144, such as during start-up. Information handling system 144 further comprises storage devices 514 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 514 may comprise software modules 516, 518, and 520 for controlling processor 502. Information handling system 144 may comprise other hardware or software modules. Storage device 514 is connected to the system bus 504 by a drive interface. The drives and the associated computer-readable storage devices provide nonvolatile storage of computer-readable instructions, data structures, program modules and other data for information handling system 144. In one aspect, a hardware module that performs a particular function comprises the software component stored in a tangible computer-readable storage device in connection with the necessary hardware components, such as processor 502, system bus 504, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 144 is a small, handheld computing device, a desktop computer, or a computer server. When processor 502 executes instructions to perform “operations”, processor 502 may perform the operations directly and/or facilitate, direct, or cooperate with another device or component to perform the operations.

As illustrated, information handling system 144 employs storage device 514, which may be a hard disk or other types of computer-readable storage devices which may store data that are accessible by a computer, such as magnetic cassettes, flash memory cards, digital versatile disks (DVDs), cartridges, random access memories (RAMs) 510, read only memory (ROM) 508, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 144, an input device 522 represents any number of input mechanisms, such as a microphone for speech, a touch-sensitive screen for gesture or graphical input, keyboard, mouse, motion input, speech and so forth. Additionally, input device 522 may receive measured data obtained from transmitters 102 and at least one receiver 104 of acoustic logging tool 100, discussed above. An output device 524 may also be one or more of a number of output mechanisms known to those of skill in the art. In some instances, multimodal systems enable a user to provide multiple types of input to communicate with information handling system 144. Communications interface 526 generally governs and manages the user input and system output. There is no restriction on operating on any particular hardware arrangement and therefore the basic hardware depicted may easily be substituted for improved hardware or firmware arrangements as they are developed.

As illustrated, each individual component describe above is depicted and disclosed as individual functional blocks. The functions these blocks represent may be provided through the use of either shared or dedicated hardware, including, but not limited to, hardware capable of executing software and hardware, such as a processor 502, that is purpose-built to operate as an equivalent to software executing on a general-purpose processor. For example, the functions of one or more processors presented in FIG. 5 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) 508 for storing software performing the operations described below, and random-access memory (RAM) 510 for storing results. Very large-scale integration (VLSI) hardware embodiments, as well as custom VLSI circuitry in combination with a general-purpose DSP circuit, may also be provided.

FIG. 6 illustrates an example information handling system 144 having a chipset architecture that may be used in executing the described method and generating and displaying a graphical user interface (GUI). Information handling system 144 is an example of computer hardware, software, and firmware that may be used to implement the disclosed technology. Information handling system 144 may comprise a processor 502, representative of any number of physically and/or logically distinct resources capable of executing software, firmware, and hardware configured to perform identified computations. Processor 502 may communicate with a chipset 600 that may control input to and output from processor 502. In this example, chipset 600 outputs information to output device 524, such as a display, and may read and write information to storage device 514, which may comprise, for example, magnetic media, and solid-state media. Chipset 600 may also read data from and write data to RAM 510. A bridge 602 for interfacing with a variety of user interface components 604 may be provided for interfacing with chipset 600. Such user interface components 604 may comprise a keyboard, a microphone, touch detection and processing circuitry, a pointing device, such as a mouse, and so on. In general, inputs to information handling system 144 may come from any of a variety of sources, machine generated and/or human generated.

Chipset 600 may also interface with one or more communication interfaces 526 that may have different physical interfaces. Such communication interfaces may comprise interfaces for wired and wireless local area networks, for broadband wireless networks, as well as personal area networks. Some applications of the methods for generating, displaying, and using the GUI disclosed herein may comprise receiving ordered datasets over the physical interface or be generated by the machine itself by processor 502 analyzing data stored in storage device 514 or RAM 510. Further, information handling system 144 receive inputs from a user via user interface components 604 and execute appropriate functions, such as browsing functions by interpreting these inputs using processor 502.

In examples, information handling system 144 may also comprise tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may comprise RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be comprised within the scope of the computer-readable storage devices.

Computer-executable instructions comprise, for example, instructions and data which cause a general-purpose computer, special purpose computer, or special purpose processing device to perform a certain function or group of functions. Computer-executable instructions also comprise program modules that are executed by computers in stand-alone or network environments. Generally, program modules comprise routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

During the EM tool logging operations of FIG. 1, information handling system 144 may process different types of the real time data and post-process data originated from varied sampling rates and various sources, such as diagnostics data, sensor measurements, operations data, and or the like as collected by acoustic logging tool 100. (e.g., referring to FIG. 1). These measurements (m) from the acoustic logging tool 100 may allow for information handling system 144 to perform real-time assessments of the acoustic logging operation.

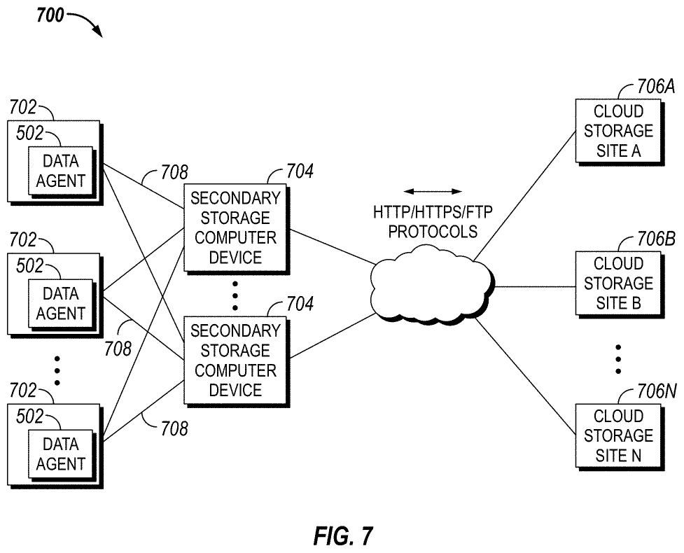

FIG. 7 illustrates an example of one arrangement of resources in a computing network 700 that may employ the processes and techniques described herein, although many others are of course possible. As noted above, an information handling system 144, as part of their function, may utilize data, which comprises files, directories, metadata (e.g., access control list (ACLS) creation/edit dates associated with the data, etc.), and other data objects. The data on the information handling system 144 is typically a primary copy (e.g., a production copy). During a copy, backup, archive or other storage operation, information handling system 144 may send a copy of some data objects (or some components thereof) to a secondary storage computing device 165 by utilizing one or more data agents 702.

A data agent 702 may be a desktop application, website application, or any software-based application that is run on information handling system 144. As illustrated, information handling system 144 may be disposed at any well site (e.g., referring to FIG. 1) or at an offsite location. The data agent may communicate with a secondary storage computing device 704 using communication protocol 708 in a wired or wireless system. The communication protocol 708 may function and operate as an input to a website application. In the website application, field data related to pre- and post-operations, notes, and the like may be uploaded. Additionally, information handling system 144 may utilize communication protocol 708 to access processed measurements, troubleshooting findings, historical run data, and/or the like. This information is accessed from secondary storage computing device 704 by data agent 702, which is loaded on information handling system 144.

Secondary storage computing device 704 may operate and function to create secondary copies of primary data objects (or some components thereof) in various cloud storage sites 706A-N. Additionally, secondary storage computing device 704 may run determinative algorithms on data uploaded from one or more information handling systems 144, discussed further below. Communications between the secondary storage computing devices 704 and cloud storage sites 706A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 706A-N, the secondary storage computing device 704 may also perform local content indexing and/or local object-level, sub-object-level or block-level deduplication when performing storage operations involving various cloud storage sites 706A-N. Cloud storage sites 706A-N may further record and maintain logs for each downhole operation or run, store repair and maintenance data, store operational data, and/or provide outputs from determinative algorithms that are located in cloud storage sites 706A-N. In a non-limiting example, this type of network may be utilized as a platform to store, backup, analyze, import, preform extract, transform and load (“ETL”) processes, mathematically process, apply machine learning algorithms, and interpret the data acquired by one or more acoustic logs.

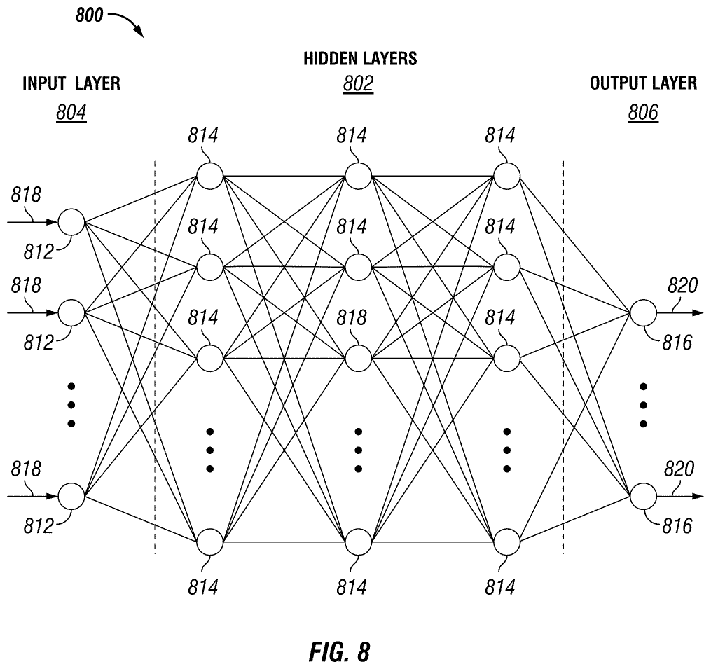

As discussed above, data measurements are processed using information handling system 144 (e.g., referring to FIG. 1) and, in examples, in conjunction with machine learning. There are many different types of machine learning models. For example, machine learning may be any form of neural network (NN), Convolutional Neural Network (CNN), Recurrent Neural Network (RNN), Deep Learning Neural Network (DNN), rand forest network, AI training, pattern recognition, Support Vector Machine (SVM), and/or the like. FIG. 8 illustrates an example of a machine learning model, specifically, a (NN). It should be noted that this is only an example, and many other forms of machine learning may be utilized. As illustrated in FIG. 8, a NN 800 is an artificial neural network with one or more hidden layers 802 between input layer 808 and output layer 806. In examples, NN 800 may be software on a single information handling system 144 (e.g., referring to FIG. 1). In other examples, NN 800 may software running on multiple information handling systems 144 connected wirelessly and/or by a hard-wired connection in a network of multiple information handling systems 144. As illustrated, input layer 804 may comprise measurement data 818 from acoustic logging tool 100 (e.g., referring to FIG. 1), and output layers 806 may be answer products 820 from the processing discussed above. During operations, measurement data 818 is given to neurons 812 in input layer 808. Neurons 812 are defined as individual or multiple information handling systems 144 connected in a network, which may compute the measurement data into graphs and/or figures using the processing techniques discussed above. The output from neurons 812 may be transferred to one or more neurons 814 within one or more hidden layers 802. Hidden layers 802 comprises one or more neurons 814 connected in a network that further process information from neurons 812 according to processing techniques discussed above. The number of hidden layers 802 and neurons 812 in hidden layer 802 may be determined by an operator that designs NN 800. Hidden layers 802 is defined as a set of information handling system 144 assigned to specific processing steps identified above. Hidden layers 802 spread computation to multiple neurons 812, which may allow for faster computing, processing, training, and learning by NN 800.

Referring back to FIG. 2, recorded flexural waves 216 and S1 mode waves 220 may be sent to information handling system 144 (e.g., referring to FIG. 1) to be processed. Standard processing techniques of flexural waves 216 and/or S1 mode waves 220 may form a two-dimensional acoustic impedance image on information handling system 144. Information handling system 144 may be configured to display processed two-dimensional acoustic impedance image. As discussed above, machine learning may be implemented by information handling system 144 to process flexural waves 216. Additionally, S1 mode waves 220 may be converted to acoustic impedance behind pipe string 138 (also called annular impedance) using established methods. The acoustic impedance may be utilized with flexural waves 216 in a machine learning model to identify material 200 behind pipe string 138. Machine learning methods such as random forest or NNs may be capable of discovering non-linear relationships between multiple inputs and outputs. With appropriate choice of tuning parameters and sufficient data, wherein sufficient data allows for capture various possible scenarios, machine learning may be used to model the link between inputs and outputs with low bias while avoiding overfitting to training data. Training data may further be utilized to train one or more machine learning models to assist in predicting or forming images. In examples, an input into machine learning models for the systems and methods describe is identified as vector v(x) for each data point described below, wherein:

x=[annulimp,mudimp,mudatt,th,anginc,offset,flexattrrec1,flexattrrec2,flexattrrec3,flexattrrec4] (1)

The variables for Equation 1 are as follows, annulimp is impedance in the annulus between pipe string 138 and formation 124 as measured by a pulse-echo transducer, mudimp and mudatt are impedance and attenuation of mud 202 inside pipe string 138, anginc and offset are the angle of incidence and transducer offset from pipe string internal surface as measured by the pulse-echo system. Additionally, flexattrrec1-flexattrrec4 are the flexural mode wavelet attributes as measured on four receivers 104, anginc and offset characterize the eccentricity of the tool, and output vector (y) is material 200 outside pipe string 138. Material 200 may be classified as solid-liquid-gas. However, any other classification may also be used for the purpose. For example, another way to classify would be to have four classes as well bonded cement, partially bonded cement, liquid, and/or gas.

Any number of vectors v(x) may be implemented in machine learning models to be trained by training data. Training data may comprise variables that were measured by acoustic logging tool 100. For example, training data may comprise impedance in wellbore 110 between pipe string 138 and formation 124 as measured by a pulsed echo sonic or ultrasonic transducer 304 (e.g., referring to FIGS. 1, 3, and 5). Additional variables may comprise impedance and attenuation of mud inside pipe string 138, an angle of incidence of sonic or ultrasonic waves 214, and transducer offset from casing internal surface as measured by acoustic logging tool 100. Other variables may comprise flexural mode wavelet attributes as measured on at least one receiver 104 and offset characterizing eccentricity of acoustic logging tool 100. Output vectors may comprise identification of material 200 (e.g., referring to FIG. 2) outside pipe string 138, such as solid-liquid-gas. However, any other classification may also be used for the purpose. For example, another way to classify would be bonded cement, partially bonded cement, liquid, and/or gas.

Variables discussed above may be synthetic data, lab data, and/or actual measurements. Lab data may encompass all measurements which may be acquired on acoustic logging tool 100. Lab data may be generated with actual transducers fired in small scale fixtures representative of conditions in wells an may include signal attributes of amplitude, wavelength, frequency, or speed for flexural waves 216 or S1 mode waves 220. Thus, the machine learning algorithm may be trained using synthetic, lab data, or actual measurements to cover the space of practical scenarios that may be encountered. This may allow for simulations, such as using a 3-D viscoelastic wave equation to train the machine learning algorithm and create a model for prediction. Features may be extracted from the waveforms generated through simulations. Features, such as flexural wave attributes from each of the at least one receiver 104 (e.g., referring to FIG. 1) may be computed by identifying the flexural wave arrival based on physics-based travel time equations, capturing the wavelet corresponding to that mode and then summing the absolute values of the amplitudes. Flexural wave attributes may comprise features such as amplitude, wavelength, frequency, speed, and the like.

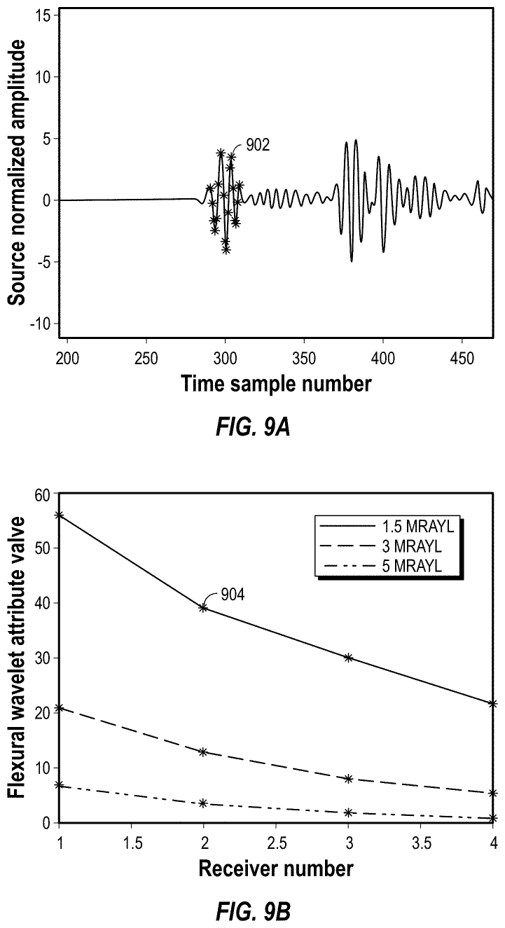

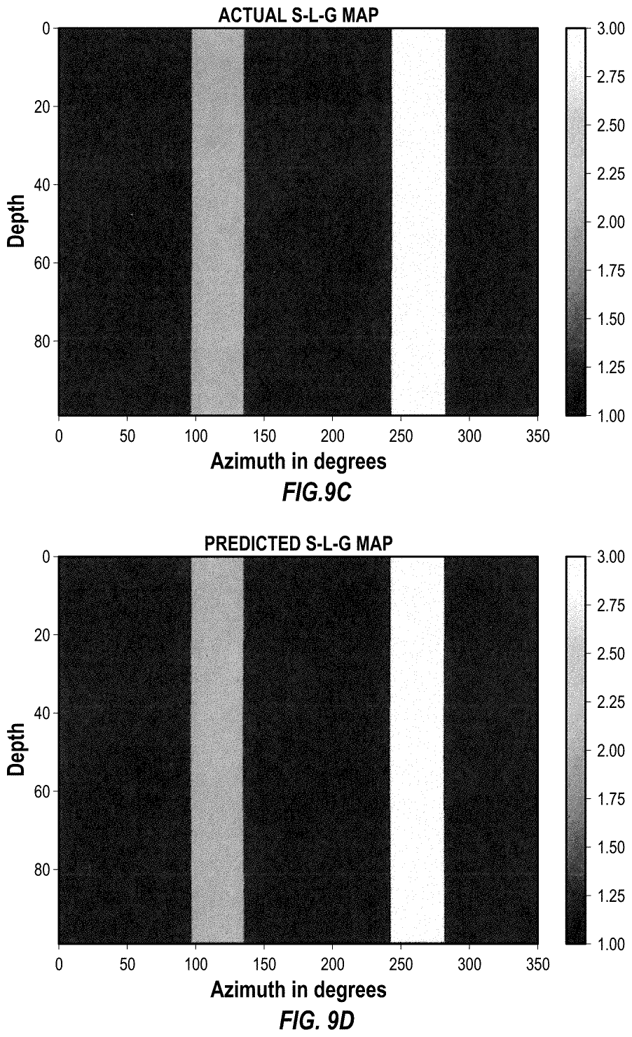

FIG. 9A shows an example of the identification of the flexural mode wavelet on the full waveform at one of the at least one receivers 104. Specific data points from receivers may be highlighted as illustrated by the asterisks 902. FIG. 9B shows how the computed attribute varies among receivers and the multiple curves in FIG. 9B show the impact of material 200 behind pipe string 138 (e.g., referring to FIG. 2), with water inside casing. Simulations with other muds 202 (e.g., referring to FIG. 2) inside pipe string 138 may also be conducted to cover various possibilities. Multiple thicknesses of pipe string 138 were additionally considered for generating the training dataset. Flexural wave attributes from receivers may be highlighted as illustrated by the asterisks 904. FIGS. 9C and 9D illustrate a test case with synthetic data and predicted material behind casing plots. The match shows how well the trained machine learning model performs. With field data, vector (x) may be computed for each depth and azimuth to generate a map depicting the condition in the annulus. Discussed below are workflows that illustrated the training of machine learning models with one or more training datasets and then using it to predict material 200 behind pipe string 138 (e.g., referring to FIG. 2).

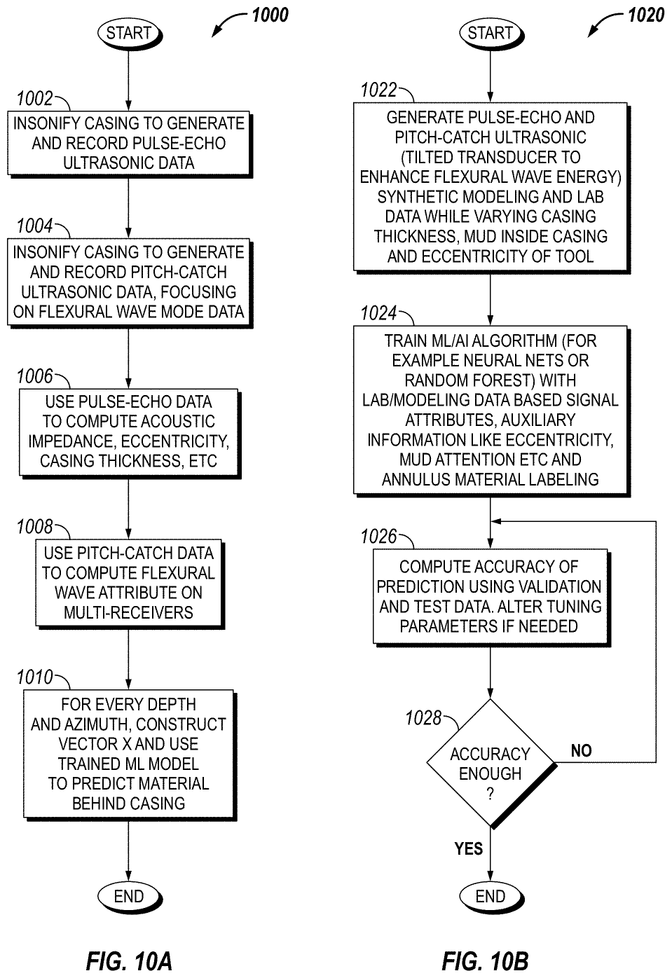

FIG. 10A illustrates workflow 1000 to determine material 200 behind pipe string 138 (e.g., referring to FIG. 2) utilizing the inputs and methods discussed above. In block 1002, acoustic logging tool 100 may insonify pipe string 138 to with sonic or ultrasonic waves, as previously described in FIG. 2. Herein, insonify pipe string 138 may be defined by transmitting acoustic waves by transmitters 102 or transducer 218 (e.g. referring to FIG. 2) to be at least partially refracted through the first interface 204 and second interface 206 where they may travel through material 200. Such acoustic waves may then subsequently refract back through second interface 206 and first interface 204 to be recorded by at least one receiver 104 or transducer 218. This is done by disposing acoustic logging tool 100 into wellbore 110 for logging operations at any suitable depth in wellbore 110. Acoustic logging tool 100 (e.g., referring to FIG. 1) may then perform a logging operation as described above, the data recorded by at least one receiver 104 (e.g., referring to FIG. 1) is processed by information handling system 144 to form an acoustic log of wellbore 110 (e.g., referring to FIG. 1) of flexural wave data in block 1004. In block 1006, pulsed-echo data is processed to determine acoustic impedance, eccentricity, pipe string thickness, and/or the like. Next, pitch-catch data is processed to compute flexural wave attributes on one or more receivers. In block 1008 acoustic wave attributes such as power, max amplitude, instantaneous amplitude, or sum of absolute amplitudes of the flexural wavelet may be calculated. Additionally, blocks 1006 and 1008 may occur simultaneously or in either order. In block 1010, for every depth and azimuth, a vector v(x) is constructed using at least processed pulsed-echo and/or pitch-catch data to form acoustic impedance, eccentricity, pipe string thickness, and acoustic wave attributes determined in blocks 1006 and 1008 with Equation (1).

A trained ML model may be trained as previously described in FIG. 8. Thus, the ML model from block 1010 may be trained by inputting synthetic data, lab data, or one or more actual measurements with known and matched outputs of at least acoustic impedance, eccentricity, pipe string thickness, or one or more acoustic wave attributes from ultrasonic or sonic wave attributes into a machine learning model. A known and matched output is defined as a previously determined output for an input. Specifically, an input may be at least acoustic impedance, eccentricity, pipe string thickness, or one or more acoustic wave attributes may have a matched output of material behind the casing. The input is compared to its matched output and adjusting with known material behind the casing to train hyper parameters. Hyper parameters within the ML model are adjusted during training to determine linear or nonlinear correlations and patterns between acoustic impedance, eccentricity, pipe string thickness, acoustic wave attributes and material behind the casing. Therefore, once trained, the trained model may receive sonic or ultrasonic pulsed-echo and/or pitch-catch data in the form of and apply vector v(x) with linear or nonlinear correlations and patterns between vector v(x) and material behind the casing to predict material behind the casing. The training set for training the ML model may include synthetic data, lab data, or actual measurements. The method for predicting material behind the casing as discussed in block 1010 may be defined as pattern recognition methods.

FIG. 10B illustrates a second workflow 1020 to train a machine learning model utilizing the inputs and methods discussed above. Workflow 1020 may begin with block 1022. In block 1022, pulse-echo and pitch-catch sonic or ultrasonic synthetic models are created using 3D visco-elastic wave simulations. As previously described, lab data is generated with actual transducers fired in small scale fixtures representative of conditions in wells. Both synthetic modeling and lab data may be generated by varying model variables to cover ranges of scenarios encountered practically. Model variables may comprise thickness of pipe string 138, attenuation of mud 202 (e.g., referring to FIG. 2) inside pipe string 138, signal attributes of lab data such as amplitude, wavelength, frequency, speed of flexural waves 216 or S1 mode waves 220, and eccentricity of acoustic logging tool 100 (e.g., referring to FIG. 1). In block 1024, a machine learning model is trained as previously describes in FIG. 4 with lab and synthetic modelling data, auxiliary information like eccentricity, mud attenuation, and characterization of material 200 behind pipe string 138. In block 1026, the accuracy of prediction is computed using validation and test data. The accuracy of the outputs from the model of block 1028 may be evaluated by comparing them to their expected outputs. If their accuracy falls below a selected threshold, tuning parameters of the model may be updated. The selected threshold is selected by a user and may be altered by a user.

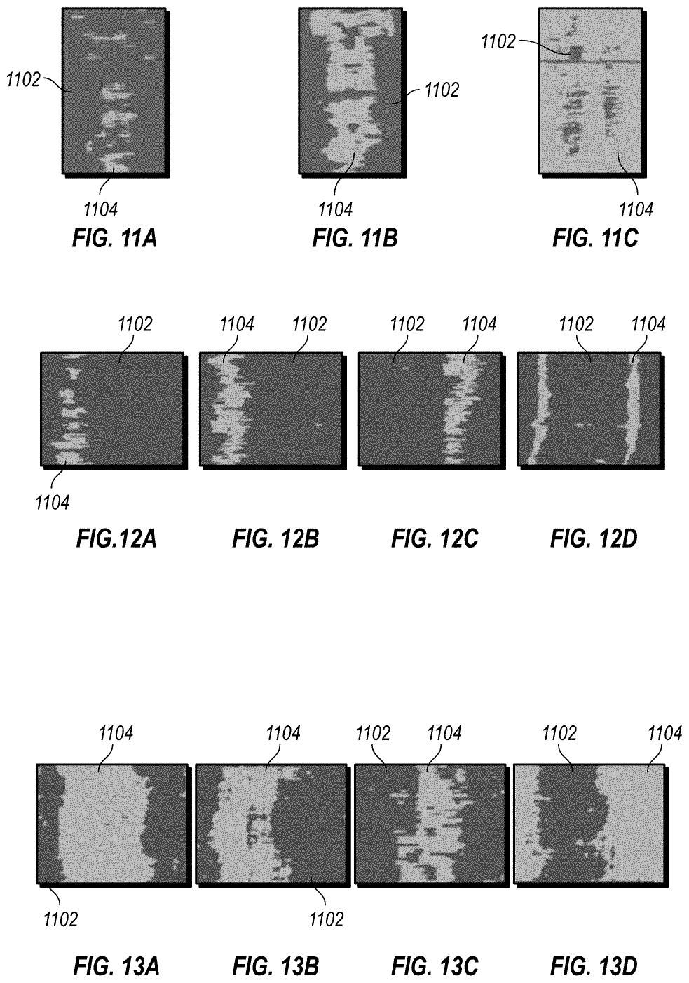

A machine learning system may be selected by a user to be trained. In examples, training data may comprise field measurements, synthetic data, and/or lab data as previously described. For example, an acoustic log may be formed from operations disclosed above. The acoustic log may be processed into a plurality of images. During this step, the acoustic log may be processed and digitized to display circumference acoustic impedance image recorded by acoustic logging tool 100. Processing and digitization of the acoustic log may be enhanced with vector v(x), determined in block 1010. FIGS. 11A-11C illustrate acoustic impedance (ZP) measurements generated from acoustic logging tool 100 and form ZP images. ZP images may be divided into approximately twenty-foot (20 ft.) lengths vertically and images may be captured sequentially through the input interval. Without limitations, acoustic impedance image may be divided into any other suitable vertical length. For example, vertical lengths may range from one foot to 100 feet. Thus, the vertical length may be any chosen length in this range. In still other examples, the vertical length may be larger than 100 feet. ZP images may further be processed into 360-pixel images in width to ensure comparability to other images. While 360 pixels is used, other numbers of pixels may also be used. Additionally, an image may be created using two regions. In examples, a single threshold may be set at 2.7 MRayls (Mega Rayls) and measurements over the threshold are placed in region 1102 while measurements under the threshold are placed in region 1104. In other examples, more thresholds may be added to further divide the image into more regions. The newly formed images may then be rotated through 180 degrees and captured again, they may also be vertically flipped and further captured. The purpose of this phase is to build a library of real ZP images that may be approximately twenty feet (20) in height. Additionally, synthetic data may be used to supplement the library using computer software to generate fictional material state behind casing maps of varying quality.

ZP images formed may be manually sorted by a user into different classifications with vector v(x). For example, different classifications may comprise narrow channel (as illustrated in FIGS. 12A-12D), wide channel (as illustrated in FIGS. 13A-13D), very wide channel, partial bond, good bond, and/or free. Any other types of classifications may also be used. The exact breakdown of channel size may or may not be used and it is possible to group these sub classifications into one category of ‘channel.’ The classified images may be saved into one or more libraries, which may be accessed for machine learning operations and/or additional processing. After a library is formed and classifications have been created, machine learning models may be trained with the library and classifications. This may allow an information handling system 144 (e.g., referring to FIG. 1) that runs a trained machine learning model to automatically sort images captured by acoustic logging tool 100 (e.g., referring to FIG. 1).

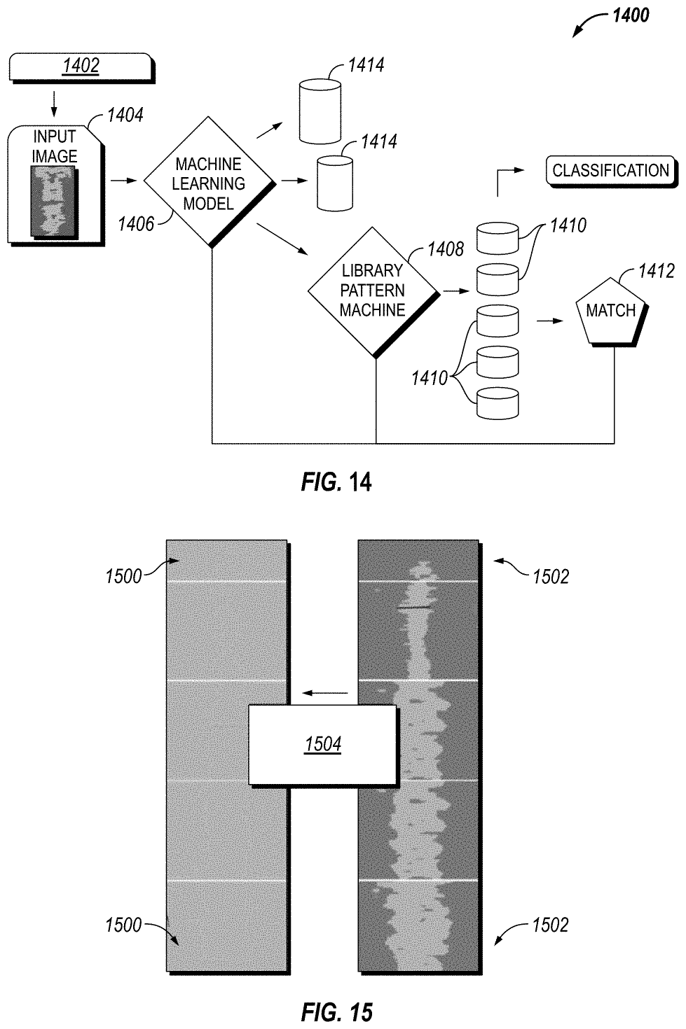

FIG. 14 illustrates workflow 1400 for machine learning operations. For example, in block 1402 logging operations are performed in which Acoustic Impedance (ZP) data is captured from an acoustic logging tool 100 and fed into information handling system 144. In block 1404, the data is evaluated using machine learning and pattern recognition methods, such as the ones discussed above in workflow 1000 (e.g., referring to FIG. 10). A first step may be to generate a false color image of acoustic impedance data using a cut-off between solid and liquid, represented by regions 1102 and 1104, for example 2.7 MRayls. In block 1406, the data may then be passed through a trained machine learning model that to determine free coverage (or no coverage) and high coverage of material 200 behind pipe string 138 (e.g., referring to FIG. 2). If the image is determined by the trained machine learning model to not represent either of these two classifications in block 1414 then it is passed to the Library Pattern Recognition phase in block 1408. As discussed previously, one or more libraries 1410 comprise data samples that may have been interpreted and classified by a user. The machine learning model may then compare the input image to every sample in the library. The closest matching image is then selected as a match in block 1412. Effectively a comparable log which is already interpreted is built through pattern matching.

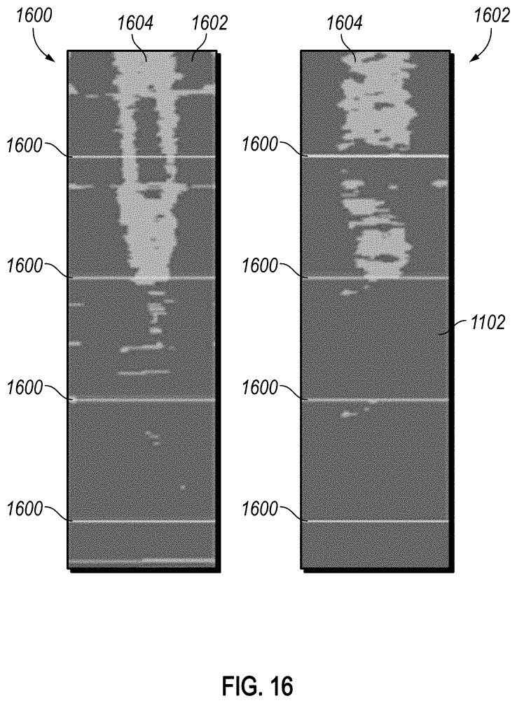

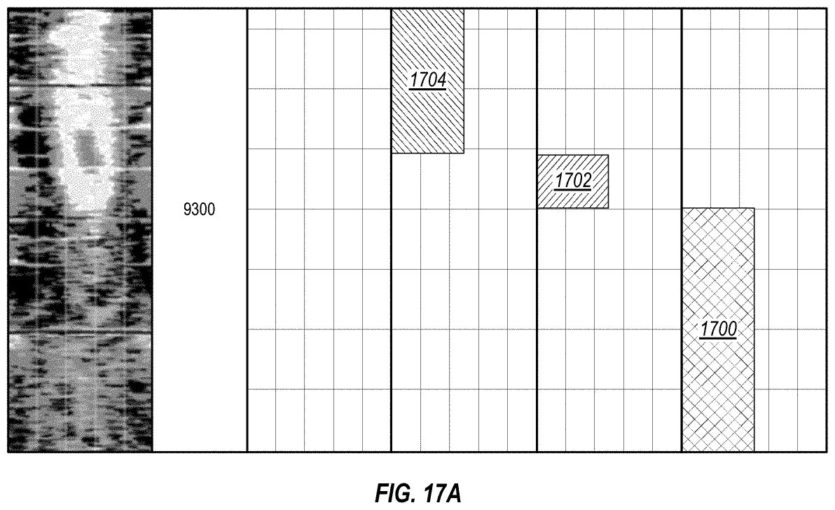

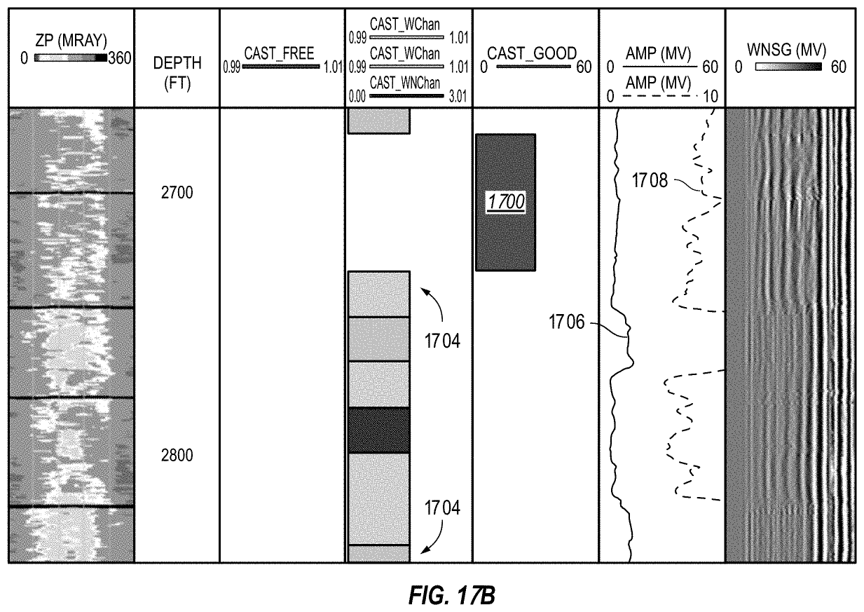

As illustrated in FIG. 15, pattern matching is illustrated. For example, input image 1500 is log data taken from acoustic logging tool 100 (e.g., referring to FIG. 1) during logging operations, described above. Input image 1500 is compared to library image 1502 using a trained machine learning model in block 1504 (e.g., referring to FIG. 15). As illustrated in FIG. 16, input image 1500 and library image 1502 may be divided by height, as discussed above, by sections 1600 to ease comparison. FIGS. 17A and 17B illustrates a comparison that shows a good match 1700, a partial match 1702, and a channeled match 1704. After verification that outputs of processing by machine learning are correct, then the output and the associated image may be copied to the library, or it may be manually selected by the human into the correct classification. Any future use of the system then has access to this sample to compare with. Additionally, Waveform Microseismogram (WMSG) measurements demonstrated represent formation arrivals used to identify when the pipe is acoustically coupled to the formation and the absence or attenuation of casing arrivals, ‘Chevron’ collar signatures, and the amount of attenuation within the WMSG. Sonic or ultrasonic waves 214 recorded by at least one receiver 104 as flexural waves 216 or S1 mode waved 220 by received by transducer 218 may be illustrated by an amplitude vs depth log 1706. Additionally, amplitude vs depth log 1706 may be scaled to form scaled amplitude vs depth log 1706. Additionally, impedance measurements (ZP MRAY) may be provided for Sonic or ultrasonic waves 216 recorded by receivers 104 or S1 mode waved 220 by received by transducer 218.

Methods and systems disclosed above are an improvement over current technology. Specifically, the implementation of machine learning model with sonic or ultrasonic data to predict material outside the casing. Implementations of sonic or ultrasonic data to serve as an input into a machine learning model may comprise casing thickness, mud inside casing properties, and eccentricity information. Additionally, sonic or ultrasonic data such as flexural wave data collected in an array of three or more receivers directly may enhance accuracy of sonic or ultrasonic data. For example, flexural wave data collected in two receivers to get an attenuation value and use it as a basis to predict the material outside the casing. The systems and methods disclosed herein may comprise any of the various features of the systems and methods disclosed herein, including one or more of the following statements.

Statement 1: The method for identifying a material behind a pipe string may comprise disposing an acoustic logging tool into a wellbore, insonifying a pipe string within the wellbore with the acoustic logging tool, recording sonic or ultrasonic data with the acoustic logging tool, inputting the sonic or ultrasonic data into a trained machine learning model, and identifying the material behind the pipe string using the machine learning model.

Statement 2. The method of statement 1, further comprising identifying flexural wave model data from the sonic or ultrasonic data.

Statement 3. The method of any previous statements 1 or 2, further comprising calculating an acoustic impedance, an eccentricity, and a thickness of the pipe string from the sonic or ultrasonic data.

Statement 4. The method of any previous statements 1-3, further comprising calculating one or more flexural wave attributes from one or more receivers using the sonic or ultrasonic data.

Statement 5. The method of any previous statements 1-4, further comprising identifying the material behind the pipe string at one or more depths and one or more azimuths in the wellbore.

Statement 6. The method of any previous statements 1-5, wherein an input comprising at least an acoustic impedance, an eccentricity, a pipe string thickness, or one or more acoustic wave attributes is used to train the trained machine learning model.

Statement 7. The method of statement 6, further comprising determining a correlation between the input and a matched output of the trained machine learning model.

Statement 8. The method of any previous statements 6 or 7, wherein the sonic or ultrasonic data is from a pulsed-echo operation, a pitch-catch operation, or any combination thereof.

Statement 9. The method of any previous statements 6-8, wherein the input is synthetic data, lab data, or one or more actual measurements.

Statement 10: The method for identifying a material behind a pipe string may comprise generating synthetic modeled data from a plurality of lab data and one or more models, training a machine learning model with the synthetic modeled data, and identifying an accuracy of the machine learning model.

Statement 11. The method of statement 10, wherein the one or more models comprises a pulse-echo synthetic model or a pitch-catch synthetic model.

Statement 12. The method of any previous statements 10 or 11, wherein the machine learning model comprises one or more variables that comprise one or more pipe casing thickness, an eccentricity of an acoustic logging tool, and a mud in the pipe string.

Statement 13. The method of statement 12, further comprising training the machine learning model by determining a correlation between the one or more variables and a matched output.

Statement 14: The system for identifying a material behind a pipe string may comprise an acoustic logging tool comprising one or more transmitters for insonifying a pipe string within a wellbore, one or more receivers for recording sonic or ultrasonic data, and a transducer configured to record a sonic or ultrasonic data. The system may further comprise an information handling system that inputs the sonic or ultrasonic data into a machine learning model and identifies the material behind the pipe string using the machine learning model.

Statement 15. The method of statement 14, wherein the information handling system further identifies flexural wave mode data from the sonic or ultrasonic data recorded by the one or more receivers or the transducer.

Statement 16. The method of any previous statements 14 or 15, wherein the information handling system further identifies an acoustic impedance, an eccentricity, and a thickness of the pipe string from the sonic or ultrasonic data recorded by the one or more receivers or the transducer.

Statement 17. The method of any previous statements 14-16, wherein the information handling system identifies one or more flexural wave attributes from the one or more receivers using the sonic or ultrasonic data recorded by the one or more receivers or the transducer.

Statement 18. The method of any previous statements 14-17, wherein the information handling system identifies the material behind the pipe string at one or more depths and one or more azimuths in the wellbore.

Statement 19. The method of any previous statements 14-18, wherein the information handling system trains the machine learning model with a pattern recognition.

Statement 20. The method of any previous statements 14-19, wherein one or more acoustic impedance images are used for the pattern recognition.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any comprised range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method for identifying a material behind a pipe string comprising:
disposing an acoustic logging tool into a wellbore;
insonifying a pipe string within the wellbore with the acoustic logging tool;
recording sonic or ultrasonic data with the acoustic logging tool;
inputting the sonic or ultrasonic data into a trained machine learning model; and
identifying the material behind the pipe string using the trained machine learning model.

2. The method of claim 1, further comprising identifying flexural wave model data from the sonic or ultrasonic data.

3. The method of claim 1, further comprising calculating an acoustic impedance, an eccentricity, and a thickness of the pipe string from the sonic or ultrasonic data.

4. The method of claim 1, further comprising calculating one or more flexural wave attributes from one or more receivers using the sonic or ultrasonic data.

5. The method of claim 1, further comprising identifying the material behind the pipe string at one or more depths and one or more azimuths in the wellbore.

6. The method of claim 1, wherein an input comprising at least an acoustic impedance, an eccentricity, a pipe string thickness, or one or more acoustic wave attributes is used to train the trained machine learning model.

7. The method of claim 6 further comprising determining a correlation between the input and a matched output of the trained machine learning model.

8. The method of claim 6, wherein the sonic or ultrasonic data is from a pulsed-echo operation, a pitch-catch operation, or any combination thereof.

9. The method of claim 6, wherein the input is synthetic data, lab data, or one or more actual measurements.

10. A method for identifying a material behind a pipe string comprising:
generating synthetic modeled data from a plurality of lab data and one or more models;
training a machine learning model with the synthetic modeled data; and
identifying an accuracy of the machine learning model.

11. The method of claim 10, wherein the one or more models comprises a pulse-echo synthetic model or a pitch-catch synthetic model.

12. The method of claim 10, wherein the machine learning model comprises one or more variables that comprise one or more pipe casing thickness, an eccentricity of an acoustic logging tool, and a mud in the pipe string.

13. The method of claim 12, further comprising training the machine learning model by determining a correlation between the one or more variables and a matched output.

14. A system for identifying a material behind a pipe string comprising:
an acoustic logging tool comprising:
one or more transmitters for insonifying a pipe string within a wellbore;
one or more receivers for recording sonic or ultrasonic data; and
a transducer configured to record a sonic or ultrasonic data; and
an information handling system that:
inputs the sonic or ultrasonic data into a machine learning model; and
identifies the material behind the pipe string using the machine learning model.

15. The system of claim 14, wherein the information handling system further identifies flexural wave mode data from the sonic or ultrasonic data recorded by the one or more receivers or the transducer.

16. The system of claim 14, wherein the information handling system further identifies an acoustic impedance, an eccentricity, and a thickness of the pipe string from the sonic or ultrasonic data recorded by the one or more receivers or the transducer.

17. The system of claim 14, wherein the information handling system identifies one or more flexural wave attributes from the one or more receivers using the sonic or ultrasonic data recorded by the one or more receivers or the transducer.

18. The system of claim 14, wherein the information handling system identifies the material behind the pipe string at one or more depths and one or more azimuths in the wellbore.

19. The system of claim 14, wherein the information handling system trains the machine learning model with a pattern recognition.

20. The system of claim 19, wherein one or more acoustic impedance images are used for the pattern recognition.
